(19) United States
(12) Patent Application Publication
(10) Pub. No.: US 2026/0326056 A1
(43) Pub. Date: Oct. 22, 2026

(54) SYSTEM AND METHOD FOR PREPARATION OF A BUFFER LIQUID

(71) Applicant: Cytiva Sweden AB, Uppsala (SE)

(72) Inventors: Karolina Busson, Uppsala (SE); Therese Westman, Uppsala (SE); Enrique Carredano, Uppsala (SE)

(21) Appl. No.: 19/486,340

(22) PCT Filed: May 21, 2024
(86) PCT No.: PCT/EP2024/063923

§ 371 Date: Nov. 20, 2025

(30) Foreign Application Priority Data
May 25, 2023 (SE) 2350640-5

(51) Int. Cl. B01F 35/21; B01F 23/40; B01F 35/11; B01F 35/221; B01F 35/75; B01F 35/83; B01F 101/23; C11D 3/04

(52) U.S. Cl. CPC B01F 35/2132; B01F 23/49; B01F 35/11; B01F 35/2133; B01F 35/2211; B01F 35/75471; B01F 35/83; C11D 3/044; B01F 2101/23

(57) ABSTRACT

A system (10) for preparing a mixed buffer liquid is disclosed, comprising a conduit (110) for conveying the mixed buffer liquid, a supply arrangement (120) for supplying a first buffer substance, a second buffer substance, and a salt substance to the conduit, thereby forming the mixed buffer liquid, a control sensor arrangement (130) configured to output a signal indicating a pH level of the mixed buffer liquid, and a controller (140) configured to control the operation of the supply arrangement based on the signal from the control sensor arrangement (130). The control sensor arrangement 130 comprises a first pH sensor (131) of a first sensor type, a second pH sensor (132) of a second sensor type, and a control sensor valve arrangement (135) operable to control the flow of mixed buffer liquid to selectively bypass at least one of the first pH sensor (131) and the second pH sensor (132).

### TECHNICAL FIELD

The present invention relates to the preparation of mixed buffer liquids, and more specifically to a system and a method for providing a mixed buffer liquid in a conduit.

### BACKGROUND

Buffer liquids, also known as buffer solutions, are commonly known as aqueous solutions with a relatively stable pH level. Buffer liquids are appreciated for their ability to maintain a nearly constant pH value even when small amounts of acid of base are added. This is achieved by the presence of a weak acid and its corresponding conjugate base, or a weak base and its corresponding conjugate acid, in the solution. The buffer components work together to absorb or release hydrogen ions as needed, thereby keeping the pH stable.

Buffer liquids are used in a variety of applications, including chemical analysis, pharmaceutical manufacturing, and biological research. One example application is liquid chromatography, in which the buffer liquid is used to control the pH and ionic strength of the mobile phase that carries the sample through the chromatographic column, where the separation occurs based on the differential interaction between the sample components and a stationary phase.

The buffer liquid may be prepared by mixing controlled amounts of an acid and a base to water while measuring the resulting pH level. The pH level may be measured using various sensor arrangements, such as a pH meter measuring a potential difference between an internal reference electrode and an outer reference electrode, which through a reference junction is in electrical contact with the mixed buffer liquid.

It is an object of the present invention to provide an improved technology for controlling the preparation of mixed buffer liquids.

### SUMMARY

According to a first aspect of the present invention, there is provided a system for preparing a mixed buffer liquid. The system comprises a conduit for conveying the mixed buffer liquid, and a supply arrangement for supplying a first buffer substance, a second buffer substance, and a salt substance to the conduit, thereby forming the mixed buffer liquid. The system further comprises a control sensor arrangement configured to output a signal indicating a pH level of the mixed buffer liquid, and a controller configured to control the operation of the supply arrangement based on the signal from the control sensor arrangement. The control sensor arrangement is arranged to access the mixed buffer liquid downstream of the supply arrangement, and further comprises a first pH sensor of a first sensor type, a second pH sensor of a second sensor type, and a control sensor valve arrangement. The control sensor valve arrangement is operable to control the flow of mixed buffer liquid to selectively bypass at least one of the first pH sensor and the second pH sensor.

According to a second aspect of the present invention, there is provided a method for providing a mixed buffer liquid in a conduit. The method comprises supplying, by means of a supply arrangement, at least one of a first buffer substance, a second buffer substance, or a salt substance to the conduit to form the mixed buffer liquid. The method further comprises receiving a signal indicating a pH level of the mixed buffer liquid downstream of the supply arrangement, controlling the operation of the supply arrangement based on the received signal, and controlling the flow of mixed buffer liquid to selectively bypass at least one of a first pH sensor and a second pH sensor of the control sensor arrangement, wherein the first pH sensor is of a first sensor type and the second pH sensor is of a second sensor type.

The present invention is based on the discovery of the previously unrecognised problem of the so called ‘salt memory effect’, which causes pH sensors that have been in contact with buffer liquids with added salt, such as NaCl, to report wrong values when transferred to buffers with no added salt. Even if the error in reported values has been observed to decline over time, the error may lead to initial problems when switching to buffer liquids with no added salt. The discovery of this problem has inspired the inventors to propose a technology in which two sensors are employed, which can be selectively bypassed depending on the salt content of the actual buffer liquid. This allows one of the sensors to be used exclusively for buffer liquids with added salt, and the other sensor to be used exclusively for buffer liquid with no added salt.

Various sensor types are associated with various operating ranges and operating conditions in which the sensor is expected to operate correctly and produce reliable output. The operation of the sensor is for example influenced by the type of sensing element used, the sensitivity and resolution of the sensor, and the method of signal processing and output. Using the sensor outside the specified operating range or in environmental conditions other than the ones specified may lead to inaccurate or unreliable results.

This can be a challenge for systems that are expected to be able to handle various types of mixed buffer liquids, such as liquids with low conductivity (e.g., having no or very little added salt) or high conductivity (e.g., with added salt), as well as cleaning solutions used during clean-in-place (CIP) processes in which a cleaning solution is circulated through the system to remove any residual material from the previous batch. Ideally, the sensor should be able to operate both under low conductivity conditions and high conductivity conditions, as well as be CIP and autoclaving resistant.

Beneficially, the present invention provides a dual mode arrangement in which one sensor type may be used for some conditions, such as low conductivity liquids, and another sensor type may be used for other conditions, such as high conductivity liquids or CIP. The first and second sensor types may hence be of the same type, i.e., similar or identical, or of different types, depending on the application and the type of mixed buffer liquids being used. In case the salt memory effect is the primary problem to be avoided, two identical sensor types may be arranged in the dual-mode configuration that allows a first one of the sensors to be dedicated to buffer liquids with added salt and a second one of the sensors to be dedicated to buffer liquids with no or very little added salt. Alternatively, by configuring the control sensor arrangement with two different types of pH sensors it is possible to utilise the different strengths of the respective sensor types while avoiding their respective weaknesses. The first sensor type may for example be better suited for high conductivity conditions (e.g., solutions with added salt) than the second sensor type, which may be more susceptible to the salt memory effect and therefore be less suited for situations where both low conductivity and high conductivity buffer liquids occur. In further examples, the first sensor type may be configured to withstand NaOH, while the second sensor type is not CIP resistant.

The dual mode arrangement may be understood as an arrangement configured to cause the flow of mixed buffer liquid to selectively bypass one of the sensors so as to not expose that sensor environmental conditions other than the specified operating conditions. Hence, the first sensor may be bypassed when preparing a mixed buffer liquid with no added salt, such that the pH level instead is measured by the second sensor. Accordingly, the second sensor may be bypassed when preparing a mixed buffer liquid with added salt, such that the pH level instead is measured by the first sensor. For this purpose, the first and second sensor types may be identical. In a similar manner, the dual mode arrangement may enable the flow of cleaning solution to be routed past the one of the sensors that is best suited for withstanding NaOH, while the other sensor is bypassed.

In an embodiment, the controller is configured to evaluate the pH level of the mixed buffer liquid based on the signal from the control sensor arrangement, and to provide relative mixing ratios of the first buffer substance and the second substance to obtain a predefined pH level of the mixed buffer liquid. The controller may thus provide an automatic control of the mixing process for preparing the mixed buffer liquid, in which the output from the control sensor arrangement is used to provide corrective feedback helping to achieve the desired pH level. Beneficially, the controller allows for the desired pH level may be reached without requiring human input.

In an embodiment, the system further comprises a sample inlet that is fluidically connected to the conduit and configured to supply a sample to the conduit. The sample may thus be added to, and mixed with, the mixed buffer liquid conveyed by the conduit. In an embodiment, the sample inlet may be arranged downstream of the control sensor arrangement.

In an embodiment, the system may further comprise a monitoring sensor arrangement that is arranged downstream of the control sensor arrangement and, optionally, downstream the sample inlet. The monitoring sensor arrangement may hence be configured to output a signal indicating a pH level of the mixed buffer liquid when comprising the sample. The monitoring sensor arrangement may be employed to verify the pH level of the mixed buffer liquid before it is conveyed to a downstream processing device, such as a chromatographic column, or output to a bag or container for later use. For this purpose, the system may be provided with a release valve arrangement that is configured to control a release of the mixed buffer liquid from the conduit to the processing device, bag, or container. The operation of the release valve may be controlled by the controller as mentioned above. The controller may be configured to evaluate the pH level of the mixed buffer liquid based on the signal from the control sensor arrangement or monitoring sensor arrangement and to control the operation of the release valve arrangement based on the evaluated pH level. The controller may, for example, be configured to release the mixed buffer liquid from the conduit only if the evaluated pH level lies within a predetermined range. Should the evaluated pH level lie outside the predetermined range, the release valve may be operated to bypass the processing device, or other downstream equipment such as a bag or container.

In an embodiment, the monitoring sensor arrangement comprises a third pH sensor of the first sensor type, a fourth pH sensor of the second sensor type, and a monitoring sensor valve arrangement that is operable to direct the flow of mixed buffer liquid to selectively bypass at least one of the third pH sensor and the fourth pH sensor. The monitoring sensor arrangement may hence be configured in a similar way as the control sensor arrangement described above and may be operated in a dual mode in which the mixed buffer liquid is caused to selectively bypass one of the third and fourth sensors at the time. Hence, the third sensor may be bypassed when preparing a mixed buffer liquid with no added salt, such that the pH level instead is measured by the fourth sensor while the third sensor is not exposed to the flow of mixed buffer liquid. Accordingly, the fourth sensor may be bypassed when preparing a mixed buffer liquid with added salt, such that the pH level instead is measured by the third sensor. Further, the monitoring sensor arrangement may enable a flow of cleaning solution to be routed via the one of the sensors that is best suited for withstanding CIP, such as exposure to NaOH, while the other sensor is bypassed.

In an embodiment, each of the first sensor type and the second sensor type may be a potentiometric pH sensor that operates by measuring a potential difference between an internal reference electrode and an outer reference electrode in electrical contact with the mixed buffer liquid. Thus, each of the first and second sensor type may comprise a reference junction arranged to form a selective barrier to the mixed buffer liquid. The selective barrier may be referred to as a membrane or plug, having a porous structure allowing ion transport. An average pore size of the reference junction of the first sensor type may be smaller than an average pore size of the reference junction of the second sensor type. Beneficially, a relatively large pore size has been observed to cause the pH sensor to be faster and more stable compared to sensors having relatively small pore sizes. Sensors with relatively large pore sizes have further been observed to be better suited for low conductivity liquids, that is, mixed buffer liquids with low ionic strength and/no added salt. For these liquids, a sensor with a relatively large pore size may advantageously generate a more accurate and reliable output compared to sensors with a relatively small pore size.

A relatively small pore size, on the other hand, may advantageously facilitate the use of a pressurised reference electrolyte, which has been observed to improve the pH sensor's ability to withstand cleaning solutions comprising, for example, NaOH, as well as long-time exposure to pure water. This type of sensors may hence be referred to as CIP and autoclaving resistant sensors. They have also been observed to be less sensitive to the salt memory effect. The porosity of the reference junction allows the reference electrolyte to slowly seep through the reference junction into the buffer liquid, and by reducing the average pore size, the reference electrolyte may last longer before a refill is needed or the sensor has to be replaced. Pressurising the reference electrolyte may further reduce the potential drift over time, leading to more stable measurements. Further, the pressure differential over the barrier may help preventing ingress of contaminants and ions.

It has been observed that some pH sensors with a pressurised reference electrolyte may exhibit a somewhat reduced accuracy and stability at low conductivities (such as mixed buffer liquids with very little or no added salt), especially when compared with the above-mentioned sensor types with relatively large pore sizes. The dual mode operation of the present invention however addresses this issue, as the pressurised pH sensor may be bypassed when low conductivity buffer liquids are being prepared. The pH level of the low conductivity buffer liquid may instead be measured by the large pore size sensor.

In an embodiment, the first pH sensor may be bypassed in response to the mixed buffer liquid comprises a relatively low conductivity, such as below 5 mS/cm, such as 2 mS/cm or less. For the purpose of the present disclosure, mixed buffer liquids with a relatively low conductivity may be understood as mixed buffer liquids with a relatively low ionic strength or concentration, and for which no or very little salt has been added during the preparation.

Further, the second pH sensor may be bypassed in response to the mixed buffer liquid comprising a relatively high conductivity, such as 5 mS/cm or more. In the context of the present invention, mixed buffer liquids with a relatively high conductivity may be understood as liquids to which at least 50 mM of NaCl has been added during the preparation. A significant salt memory effect has been observed for solutions having an added NaCl concentration of 50 mM or more, whereas the salt memory effect can be considered as less significant or even negligible for NaCl concentrations below 50 mM. Bypassing the second pH sensor for mixed buffer liquids having added NaCl concentrations of 50 mM and above may therefore reduce the risk that the second pH sensor is affected by the salt memory effect.

It will be appreciated that the mixed buffer liquid may be prepared from a weak acid and a weak base, or a weak acid and a strong base, or a weak base and a strong acid. Exemplary buffer liquids that may be prepared using the present system include:
phosphate-buffered saline (with the first buffer substance being disodium hydrogen phosphate and the second buffer substance being at least one of sodium chloride, potassium chloride, and potassium dihydrogen phosphate),
sodium acetate buffers (with the first buffer substance being acetic acid and the second buffer substance being sodium acetate),
citrate buffers (with the first buffer substance being citric acid and the second buffer substance being sodium citrate),
tris buffers (with the first buffer substance being tris-HCl and the second buffer substance being tris base, and
bis-tris buffers (with the first buffer substance being bistris-HCl [and the second buffer substance being bistris base, to mention a few.

It will be appreciated that the above-mentioned buffer substances sometimes may be referred to as ‘buffer-salts’, which are examples of so-called weak electrolytes that do not necessarily dissociate completely into their ionic components. Instead, they contribute to the buffer solution, in which they assume an equilibrium with water.

The term ‘salt substance’, on the other hand, generally refers to a group of strong electrolytes that typically are fully disassociated when dissolved in water. The salt substance may, for example, refer to NaCl, which may be added to the mixed buffer liquid to enhance its buffering capacity. Further example includes KCl, which may be added to increase the ionic strength of the buffer liquid, which can affect the conductivity coefficients of the acid and its conjugate base, or to make use of the chaotropic or water displacement properties of the salt. This, in turn, can alter the equilibrium constant of the reaction that governs the buffer system, making it more effective at resisting changes in pH. Additionally, the presence of salt substance can also reduce the activity coefficient of the acid or base, which can reduce the extent of ionisation of the acid or base, resulting in a smaller change in pH upon addition of an acid or base. It will be understood that the term ‘salt’ or ‘salt substance’ as used in the present disclosure generally refers to this type of substance, rather than the acid and base substances used for forming the buffer system.

The term sample, or ‘feed’, generally refers to a mixture of biological molecules in which a product of interest is contained, and which is supplied to the column for further purification. The result of the entire purification process may be referred to as a product. Examples of samples include sera from human plasma or fractions of thereof, a feed from a cell culture containing monoclonal antibodies, and purified fractions of the same.

Further features and advantages of the invention will become apparent from the following description of preferred embodiments of the invention, given by way of example only, which is made with reference to the accompanying drawings

### BRIEF DESCRIPTION OF THE DRAWINGS

FIG. 1 shows a schematic diagram of a system for preparing a mixed buffer liquid according to an embodiment of the present invention.

FIG. 2 shows a schematic cross section of a pH sensor according to an embodiment of the present invention.

FIG. 3 is a schematic outline of a system according to an embodiment of the present invention.

FIG. 4 is a schematic block diagram illustrating various actions of a method according to an embodiment of the present invention.

### DETAILED DESCRIPTION

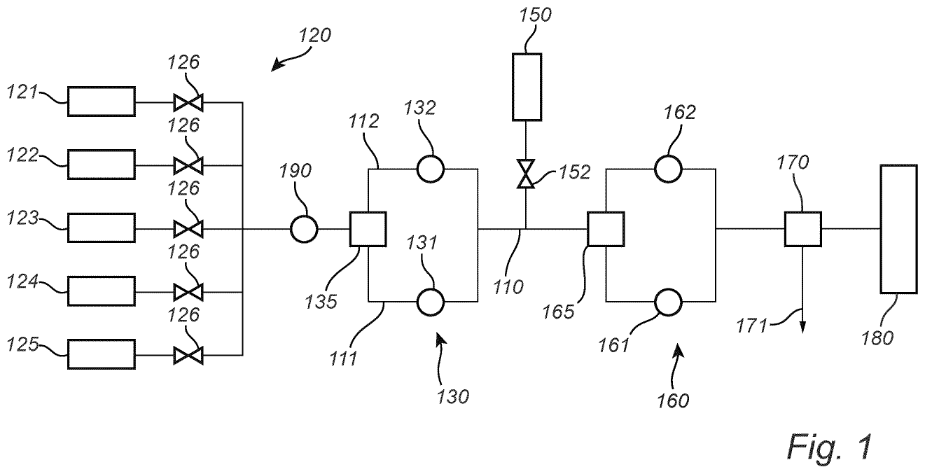

FIG. 1 is a schematic diagram of a system 10 for preparing a mixed buffer liquid according to an embodiment of the present invention. The system 10 comprises a conduit 110 for conveying the mixed buffer liquid, a supply arrangement 120 for supplying at least one of a first buffer substance, a second buffer substance, and a salt substance to the conduit to form the mixed buffer liquid. A control sensor arrangement 130 is provided to output a signal, indicating a pH level of the mixed buffer liquid, to a controller 140 which is configured to control the operation of the supply arrangement 120 based on the control sensor arrangement 130. The signal from the control sensor arrangement 130 may hence be used as corrective feedback to the controller 140, thereby assisting in achieving the desired pH level. As illustrated in the present figure, the control sensor arrangement 130 comprises a first pH sensor 131 and a second pH sensor 132 that are arranged in a parallel configuration that allows a control sensor valve arrangement 135 to selectively bypass at least one of the first pH sensor and the second pH sensor.

Additional and optional features will be discussed in the following.

The conduit 110 is configured to convey the mixed buffer liquid to a downstream processing point 180, such as a chromatographic column, a filtration device, or a container for storing or transporting the prepared buffer liquid. The conduit 110 may be formed of stainless steel, silicone, or any other suitable material known in the art. The conduit 110 may further comprise connectors, junctions, and couplings (not shown) allowing fluids and substances to be supplied to and released from the conduit 110.

The supply arrangement 120 is configured to supply the first buffer substance, the second buffer substance, and optionally the salt substance, to the conduit 110. The first buffer substance may be supplied to the conduit via a first inlet 121, the second buffer substance via a second inlet 122, and the salt via a salt inlet 123. Further inlets may also be provided, such as an additive inlet 124 for supplying an additive to the mixed buffer liquid in the conduit 110, and a water inlet 125 for providing a flow of water (typically water for injection—WFI) which mixes with the buffer substances and, possibly, the salt and any additive.

In FIG. 1, the inlets 121-125 are fluidically connected to the conduit 110 via a respective pump 126, which may be individually operated to control the amount of buffer substance, salt, additive, or water supplied to the conduit 110 to form the mixed buffer liquid. The pumps 126 may be selected from peristaltic pumps, piston pumps, and diaphragm pumps, depending on the flow volumes and flow rates. Typically, diaphragm pumps may be used.

The first inlet 121 and the second inlet 122 may be configured to supply an acidic buffer substance and a basic buffer substance, respectively, to the conduit 110. The salt inlet may be configured to supply a salt solution (typically sodium chloride or ammonium sulphate). Examples of additive include urea, glycerol, and polysorbate solutions. The substances that are supplied to the conduit 110, that is, buffer substances, salt solutions, and additives, may also be referred to as feedstock.

The order of mixing the different feedstocks may be varied, depending inter alia on the miscibilities of the respective feedstocks, substance solubilities, etcetera.

The feedstocks may be provided in tanks that are coupled to the respective inlets 121-125. Optionally, several different feedstock tanks may be provided for each inlet 121-125. For instance, several tanks with solutions of different salts (or salt mixtures) or salt solutions at different concentrations may be provided for the salt inlet 123. Similarly, several tanks comprising different acid buffer substances or one buffer substance at different concentrations may be provided for the first inlet 121, and the same may apply to the supply of basic buffer substance for the second inlet 122.

As previously mentioned, a mixed buffer liquid may be prepared from a weak acid and a weak base, a weak acid and a strong base, or a weak base and a strong acid. Exemplary buffer liquids that may be prepare using the system 10 include phosphate, acetate, citrate, tris, and bis-tris buffers.

The control sensor arrangement 130 is arranged downstream the supply arrangement 120, or at least downstream the first and second inlets 121, 122 and, typically, the salt inlet 123. The control sensor arrangement 130 comprises a control sensor valve arrangement 135 that is configured to control the flow of liquid in the conduit to bypass the first pH sensor 131 only, the second pH sensor 132 only, or, optionally, both pH sensors 131, 132. Which one of the sensors 131, 132 to bypass may depend, inter alia, on the type of sensor and its compatibility with the type of liquid conveyed by the conduit 110. In case the conduit 110 conveys a cleaning solution comprising, for example, NaOH, the flow may be directed to bypass the one of the sensors 131, 132 that is least resistant to exposure to NaOH. For buffer liquids, the conveyed flow may be directed to the one of the sensors 131, 132 that is expected to deliver the most accurate and reliable output for that particular type of buffer liquid.

As shown in the figure, the first and second pH sensors 131, 132 may be coupled in a parallel along the conduits 110, allowing them to be operated in a dual mode (i.e., a first mode in which the output is delivered by the first pH sensor 131 and in a second mode in which the output is delivered by the second pH sensor 132). The parallel configuration may be achieved by two parallel conduit portions 111, 112 that are connected to the main conduit 110 via a first and a second T-junction. The upstream T-junction may be formed by the control sensor valve arrangement 135, which may be configured to assume at least two different states: a first state in which the liquid flow is directed to the first conduit portion 111 and the first pH sensor 131, while the access to the second conduit portion 112 and the second pH sensor 132 is blocked, and in a second state in which the liquid flow is directed to the second conduit portion 112 and the second pH sensor 132, while the access to the first conduit portion 111 and the first pH sensor 131 is blocked. A third state is also conceivable, in which the liquid flow is guided into both conduit portions 111, 112, as well as a fourth state in which both conduit portions 111, 112 are blocked.

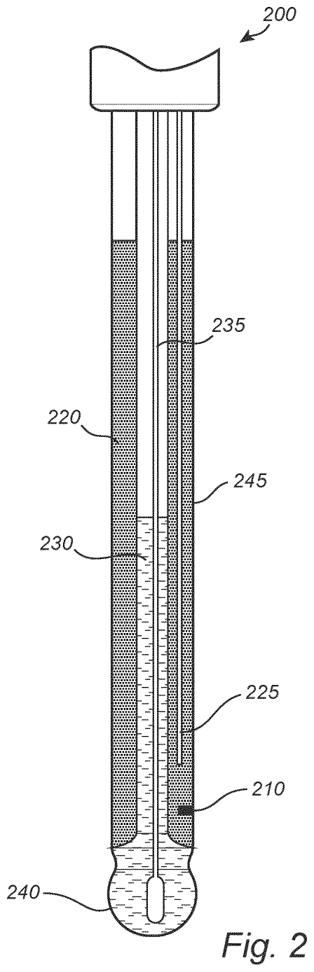

The first pH sensor 131 and the second pH sensor 132 may be potentiometric pH sensors that measure a potential difference between an internal reference electrode and an outer electrode in ionic contact with the mixed buffer liquid. The internal reference electrode may be separated from the buffer liquid by a reference junction membrane or porous plug forming a selective barrier that allows ions to pass therethrough, as will be discussed in greater detail in connection with FIG. 2. In the embodiment illustrated in FIG. 1, the first sensor 131 may comprise a reference junction membrane with an average pore size that is relatively small, or at least smaller than average pore size of a reference junction membrane of the second pH sensor 132. The average pore size of the reference junction membrane of the first pH sensor 131 may, for example, be 0.5 μm or less, such as 0.2 μm or less, while the average membrane pore size of the second pH sensor 132 may be 1 μm or more, such as 5 μm or more.

It will however be appreciated that the above merely is an example of two different types of pH sensors and their respective characteristics. Other types of sensors and distinguishing features may be used as well, depending on the type of mixed buffer liquid produced, the relevant pH range, and the conductivity of the buffer liquid. In some examples, the first sensor type and the second sensor type may be similar or even identical.

The control sensor arrangement 130 may be used for monitoring that the desired characteristics of the liquid flow in the conduit 110 are correct and stable and provide feedback to the controller 140. The controller 140 may then use the feedback to adjust the liquid flow composition (i.e., the mixing ratios) such that the measured pH converges towards the desired value.

The control sensor arrangement 130 may also be used for monitoring that the desired characteristics of the mixed buffer liquid in the conduit 110 are correct and stable. For this purpose, the controller 140 may be configured to indicate any deviation and possibly cause the release of the mixed buffer liquid from the conduit 110 to be stopped.

In the embodiment depicted in FIG. 1, characteristics of the mixed buffer liquid conveyed by the conduit may be monitored by sensor arrangement 160 arranged downstream the control sensor arrangement 130 described above. The monitoring sensor arrangement 160 may comprise a dual mode sensor arrangement similarly configured as the control sensor arrangement, i.e., a third pH sensor 161 of the first sensor type, a fourth pH sensor 162 of the second type, and a monitoring sensor valve arrangement 165 operable to direct the flow of mixed buffer liquid to selectively bypass at least one of the third pH sensor 161 and the fourth pH sensor 162. Accordingly, the monitoring sensor valve arrangement 165 may be configured to assume at least two different states: a first state in which the flow is directed to the third pH sensor 161 only, and a second state in which the liquid flow is directed to the fourth pH sensor 162 only.

The system 10 may further comprise a release valve arrangement 170 configured to control release of the mixed buffer liquid from the conduit 110. The mixed buffer liquid may, for example, be released to a container or disposable bag, or to a downstream processing device such as a chromatographic column 180 or a filter device. The operation of the release valve arrangement 170 may be controlled by the controller 140, which may be configured to evaluate the pH level of the mixed buffer liquid based on the signal from the control sensor arrangement 130 or from the monitoring sensor arrangement 160. The release valve arrangement 170 may be operated to not release the mixed buffer liquid if a deviation or error is detected in the evaluated pH level. In the example illustrated in the present figure, the chromatographic column 180 may be bypassed, should the evaluated pH level turn out to fall outside a predetermined target interval. The release valve arrangement 170 may, for instance, be configured to guide the flow of mixed buffer liquid through an outlet 171 instead of releasing the liquid to the column 180.

The system 110 may further comprise a sample inlet 150 that is fluidically connected to the conduit 110 and configured to supply a sample to the conduit 110. The supply of sample to the conduit 110 may be controlled by a pump 152, which may be similarly configured as the pumps 126 discussed above in connection with the supply arrangement 120. Hence, the pump 152 may be a peristaltic pump, a piston pump, or a diaphragm pump.

As indicated in FIG. 1, the sample inlet 150 may be connected to the conduit 110 at a position downstream the supply arrangement 120 and the control sensor arrangement 130, and upstream the monitoring sensor arrangement 160. Other configurations are however also possible, in which the sample inlet 150 is connected to the conduit 110 upstream the control sensor arrangement 130 or downstream the monitoring sensor arrangement 160.

Further sensors and other types of equipment may also be provided in the system 10. In an example, one or more conductivity sensors 190 may be arranged to generate a signal indicating a conductivity of the mixed buffer liquid. This signal may be fed to the controller 140, which may use the measured conductivity as corrective feedback when controlling the supply arrangement 120. Additional equipment may include temperature sensors, air traps, and filters (not shown).

FIG. 2 is a schematic cross section of a pH sensor 200 according to some embodiments of the present invention. The pH sensor 200 may be similarly configured as the pH sensors 131, 132, 161, 162 discussed above in with reference to FIG. 1, and may thus form part of a control sensor arrangement 130 or a monitoring sensor arrangement 160 shown in FIG. 1.

The pH sensor 200 is a potentiometric pH sensor 200 configured to measure the pH of a solution, such as the mixed buffer liquid in the conduit, based on the potential difference between an internal reference electrode 225 and an outer reference electrode 235 when the pH sensor is immersed in the mixed buffer liquid. The potential difference may be measured by a high-impedance voltmeter (not shown) connected to the electrodes 225, 235.

In this example, the internal reference electrode 225 and the outer reference electrode 235 are housed in a single glass body 245, or sensing probe, having two separate compartments that allow the internal reference electrode 225 to be immersed in an inner buffer solution 230 and the outer reference electrode 235 to be immersed in a reference electrolyte 220, respectively. A glass membrane 240 is arranged at the distal end of the glass body, within which the inner buffer solution 230 and an end portion of the outer reference electrode 235 is arranged. The outer reference electrode 235 may therefore also be referred to as a glass electrode.

Further, a reference junction 210 is arranged to form a barrier between the reference electrolyte 220 and the solution being measured. The reference junction 210 is typically formed of a small hole or a porous plug or membrane which allows the reference electrolyte 220 to come into contact with the mixed buffer liquid being measured. More specifically, the reference junction 210 may be configured to allow ions to migrate between the reference electrolyte and the solution being measured and at the same time prevent migration of contaminants that could affect the accuracy of the pH measurement.

Several types of reference junctions 210 may be used within the inventive concept, representing different sensor types that can be employed in a dual mode concept. In an example, the reference electrolyte 220 may be arranged in a porous frit, i.e., finely porous glass that allows ion to flow, wherein the reference junction 210 is formed by the interface between the porous frit and the mixed buffer liquid. In another example, the reference electrolyte 220 is separated from the mixed buffer liquid by a membrane, which for example may be formed by a porous ceramic, such as a ceramic plug, or a polymer. Generally, the reference junction 210 plays an important role in the accuracy and stability of the pH measurement and may therefore be selected with care and with respect to the properties of the liquid to which it is being exposed.

In an embodiment, the first sensor type may have porous reference junction with an average pore size that is smaller than an average pore size of the porous reference junction of the second sensor type. While relatively large pores may cause the pH sensor to be faster and more stable, especially for low conductivity liquids, they may at the same time make the sensor less capable of withstanding CIP.

A relatively small pore size, on the other hand, has been observed to improve the pH sensor's ability to withstand CIP, which typically involves cleaning solutions comprising NaOH, as well as long-time exposure to pure water, compared to sensors having a relatively large pore size. Further, sensors with a relatively small pore size have also been observed to be less resistant to cleaning solutions comprising, e.g., NaOH. They may also cause the sensor to be more affected by the salt memory effect, as discussed above. The first sensor type may, for example, have an average pore size of 0.5 μm or less, such as 0.2 μm or less, whereas the average pore size of the second sensor type may be 1 μm or more, such as 5 μm or more.

Additionally, or alternatively, the reference electrolyte 220 may be pressurised. In different words, a pressure gradient may be provided over the reference junction 210. Pressurizing the reference electrolyte 220 may improve stability, reduce contamination, and increase accuracy of measurements.

In some examples, the first sensor type of the dual mode arrangement may be of a pressurised electrolyte type, whereas the second sensor type is not. Alternatively, both sensor types are of the pressurised type.

It will be appreciated that various combinations of pressurised sensors, non-pressurised sensors, large pore size reference junctions (in some examples with an average pore size 1 μm or more), and small pore size reference junction (in some examples with an average pore size of 1 μm or more), are possible within the scope of the present invention. Hence, a pH sensor 200 may be a pressurized small pore size sensor, a pressurized large pore size sensor, a non-pressurized small pore size sensor, or a non-pressurised large pore size sensor. Each of the first sensor type and the second sensor type may be of any of these four combinations. However, in a preferred example, the first sensor type may be a pressurized small pore size sensor and the second sensor type a non-pressurized large pore size sensor.

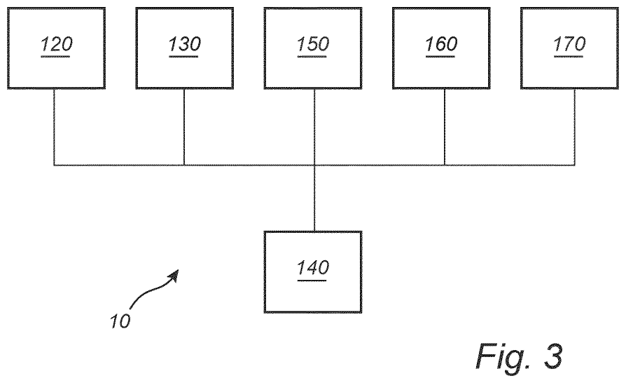

FIG. 3 is a schematic outline of a system according to an embodiment, which may be similarly configured as the system 10 discussed above with reference to FIG. 1. Hence, the system 10 comprises a supply arrangement 120 for supplying feedstocks to a conduit to form a mixed buffer liquid, a control sensor arrangement 130 configured to measure a pH level in the mixed buffer liquid, and a controller 140 for control the operation of the supply arrangement 120 based on output from the control sensor arrangement 130. Optionally, the system may further comprise a sample inlet 150, a monitoring sensor arrangement 160, and a release valve arrangement 170, as discussed above.

The output from the control sensor arrangement 130, i.e., the signal generated by the first pH sensor and/or the second pH sensor, may be transmitted to the controller 140 via a wired or wireless connection. The signal may be used by the controller 140 to evaluate the pH level of the mixed buffer liquid and provide corrective feedback to the supply arrangement 120. However, it will be appreciated that the controller 140 also may be configured to calculate an initial blending recipe for the preparation of the mixed buffer liquid, and then use the sensor feedback to adjust the resulting pH. An illustrative and non-limiting example of how such calculations can be performed will now be discussed with reference to the Debye-Hückel equation.

For mixed buffer liquids comprising lower concentrations of buffer and/or salt, an iterative calculation procedure as described in for example U.S. Pat. No. 6,221,250 may be used to determine the relative mixing ratios of the feedstocks. In this reference, a modified version of the Debye-Hückel equation is used to determine the variable proportions of the components. Further, an approximation of the ion size parameter in the Debye-Hückel equation is used. The proportions of the components are concomitantly varied in such a way as to take into account the interrelationship of the pH and the ionic strength of the mixed buffer liquid to obtain at each moment a pre-selected pH of the mixed buffer liquid.

For higher buffer and salt concentrations, a method described in International Application WO 2009/131524 A1 (PCT/SE2009/050399) may be used to determine the mixing ratios. Here, the relative component proportions are determined using the Debye-Hückel equation:

$$- log φ = \frac{{AZ}^{2} {I}^{0.5}}{1 + 0.33 \cdot {10}^{8} α {I}^{0.5}}$$

wherein A is a constant, or rather a temperature dependent parameter ~0.51 (A can accurately be calculated as A=0.4918+0.0007T+0.000004T²) where T is the temperature in degrees Celsius, Z is the charge of the ion, and the quantity a, the radii of the hydrated ions (in Å), is the ‘mean distance of approach of the ions, positive or negative’ (in the original paper of Debye and Hückel), and determining the ion size parameter a in the Debye-Hückel equation as the weighted mean ion size of all species contributing to the ionic strength of the liquid mixture, and wherein the ionic strength of each species is used as the weighting parameter. More particularly, the ion size parameter a of the Debye-Hückel equation is determined as

$$α = \frac{\sum {I}_{i} {α}_{i}}{I}$$

wherein Iᵢ is the ionic strength and ai the ion size parameter of species i, and I is the total ionic strength.

Many times, the ion size parameter in the Debye-Hückel equation may be approximated as α=0.5·(mass)^{1/3}+shell, where ‘shell’ is typically fixed at a value in the range of 3.8-4.2, such as 4.0, for positively charged ionic species, and fixed at a value in the range of 0-0.2, such as 0, for negatively charged ionic species.

The iterative procedure for determining the mixing ratios comprises (i) determining the relative component proportions, wherein the predefined ionic strength of the liquid mixture is addressed to the species according to a predefined distribution among the species; (ii) on the basis of the relative component proportions determined in (i), calculating the ionic strength of each species in the mixture, (iii) determining a new set of relative component proportions, taking account of the ionic strength calculated in (ii); and (iv) repeating steps (ii) and (iii) until a predetermined convergence criteria is met.

Any other method that can provide mixing ratios may, of course, also be used.

The controller 140 may comprise circuitry configured to carry out functions of the controller. The circuitry may comprise a processor, such as a central processing unit, CPU, microcontroller, or microprocessor configured to execute program code. The program code may for example be configured to carry out an evaluating function for evaluating a pH level based on signal output from any of the pH sensors 131, 142, 161, 162 discussed above, and a mixing ratio function for calculating relative mixing ratio of feedstock for preparing a mixed buffer liquid with predetermined characteristics (such as pH and conductivity). The controller 140 may further comprise a memory, which may be one or more of a buffer, a flash memory, a hard drive, a removable media, a volatile memory, a non-volatile memory, a random-access memory (RAM), or another suitable device. In a typical arrangement, the memory may include a non-volatile memory for long term data storage and a volatile memory that functions as a system memory for the circuitry. The memory may exchange data with the circuitry over a data bus. Accompanying control lines and an address bus between the memory and the circuitry may be present.

The processing functions of the controller 140 may be embodied in the form of executable logic routines (e.g., line of code, software programs, etc.) that are stored on a non-transitory computer readable medium (memory) of the controller 140 and are executed by the circuitry. Furthermore, the processing functions of the controller 140 may be a stand-along software application or form a part of a software application. The described functions may be considered a method that a processing unit, e.g., the processor of the circuitry is configured to carry out. Also, while the described functions may be implemented in software, such functionality may as well be carried out via dedicated hardware or firmware, or some combination of hardware, firmware and/or software.

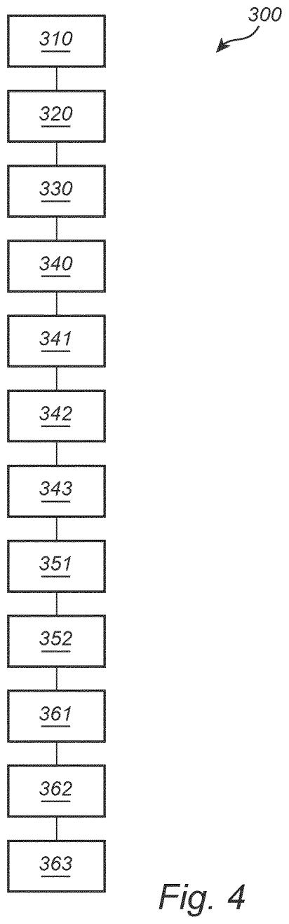

FIG. 4 is a flowchart illustrating various steps of a method 300 for providing a mixed buffer liquid according to some embodiments. The method 300 may be performed using a system 10 similar to the ones discussed above in connection with FIGS. 1 and 3. For the sake of brevity, reference is made to these figures for further details and features concerning the configuration of such as system.

In the present example, the method 300 comprises supplying 310, by means of the supply arrangement 120, at least one of a first buffer substance, a second buffer substance, or a salt substance to the conduit 110 to form the mixed buffer liquid. A flow of the mixed buffer liquid may be controlled 320 to selectively bypass at least one of the first pH sensor 131 and the second pH sensor 132 of the control sensor arrangement 130. The sensor output from the control sensor arrangement 130 may then be received 330 and used for controlling 340 the operation of the supply arrangement 120. The control 340 of the supply arrangement 120 may include an error-based feedback loop, in which the pH level of the mixed buffer liquid is calculated 341 from the received signal, a difference between the calculated pH level and a predetermined pH level is determined 342, and (adjusted) relative mixing ratios of the first buffer substance and the second buffer substance provided 343 to the supply arrangement 120 based on the determined difference. This loop of measuring the pH level and adjusting the feedstock mixing ratios may be repeated until the measured pH level converges towards a predetermined level.

The method further comprises bypassing 351 the first pH sensor 131 for mixed buffer liquids having a conductivity below 5 mS/cm, such as 2 mS/cm or less, and bypassing 352 the second pH sensor 132 for mixed buffer liquids that comprises an added salt substance.

In the present example, the method 300 further comprises receiving 361 a monitoring signal from a monitoring sensor arrangement 160, wherein the monitoring signal indicates a pH level of the mixed buffer liquid at a position in the conduit 110 where the monitoring sensor arrangement 160 is arranged. This position may be arranged downstream a sample inlet 150, and the monitoring signal may hence indicate a pH level of the mixed buffer liquid when carrying the sample. The received monitoring signal may be used for determining 362 that the pH level lies within a predetermined interval before the mixed buffer liquid is released 363 from the conduit 110. The mixed buffer liquid may for example be released to a storage container for later use, or to a processing device such as a filter or chromatographic column.

Various embodiments may provide for bypassing a sensor for cleaning in place (CIP) purposes. Preferably the bypassed sensor is of a type that is not fully CIP resistant (e.g. it may be a second sensor type that is not CIP resistant to cleaning with NaOH). Such NaOH may be provided in a CIP liquid with sodium hydroxide solutions of, for instance, 0.5 M or 1.0 M concentration (or a sodium hydroxide solution having about 0.5 M, about 1.0 M, or from about 0.5 M to about 1.0 M concentration, etc.). This thus enables certain embodiments of the invention to be provided in which daily manual intervention can be substantially eliminated or reduced. Various mechanisms are also envisaged for enabling sensor bypassing (e.g. a mechanism that could be operated to bypass a second pH sensor to enable a cleaning in place (CIP) function to be provided). Such mechanisms may also be automatically operable as needed (e.g. so as to provide a scheduled cleaning program).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system for preparing a mixed buffer liquid, comprising:
a conduit for conveying the mixed buffer liquid;
a supply arrangement for supplying a first buffer substance, a second buffer substance, and a salt substance to the conduit, thereby forming the mixed buffer liquid;
a control sensor arrangement configured to output a signal indicating a pH level of the mixed buffer liquid; and
a controller configured to control the operation of the supply arrangement based on the signal from the control sensor arrangement;
wherein the control sensor arrangement is arranged to access the mixed buffer liquid downstream of the supply arrangement, the control sensor arrangement further comprising:
a first pH sensor of a first sensor type;
a second pH sensor of a second sensor type; and
a control sensor valve arrangement operable to control the flow of mixed buffer liquid to selectively bypass at least one of the first pH sensor and the second pH sensor.

2. The system according to claim 1, wherein the controller is configured to:
evaluate the pH level of the mixed buffer liquid based on the signal from the control sensor arrangement; and
control the operation of the supply arrangement to provide relative mixing ratios of the first buffer substance and the second buffer substance to obtain a pre-defined pH level of the mixed buffer liquid.

3. The system according to claim 1, further comprising a monitoring sensor arrangement arranged downstream of the control sensor arrangement and configured to output a signal indicating a pH level of the mixed buffer liquid.

4. The system according to claim 3, wherein the monitoring sensor arrangement comprises a third pH sensor of the first sensor type, a fourth pH sensor of the second sensor type, and a monitoring sensor valve arrangement operable to direct the flow of mixed buffer liquid to selectively bypass at least one of the third pH sensor and the fourth pH sensor.

5. The system according to claim 3, further comprising a release valve arrangement configured to control release of the mixed buffer liquid from the conduit to a processing device.

6. The system according to claim 5, wherein the controller is configured to:
evaluate the pH level of the mixed buffer liquid based on the signal from the control sensor arrangement or monitoring sensor arrangement; and
control the operation of the release valve arrangement based on the evaluated pH level.

7. The system according to claim 6, further comprising a sample inlet fluidically connected to the conduit and configured to supply a sample to the conduit.

8. The system according to claim 7, wherein the sample inlet is arranged downstream of the control sensor arrangement.

9. The system according to claim 1, wherein the first sensor type is different from the second sensor type.

10. The system according to claim 9, wherein each of the first sensor type and the second sensor type comprises a reference junction membrane arranged to form a selective barrier to the mixed buffer liquid, and wherein an average pore size of the reference junction membrane of the first sensor type is smaller than an average pore size of the reference junction membrane of the second sensor type.

11. The system according to claim 10, wherein the average pore size of the reference junction of the first sensor type is 0.5 μm or less, such as 0.2 μm or less, and wherein the average pore size of the reference junction of the second sensor type is 1 μm or more, such as 5 μm or more.

12. The system according to claim 1, wherein the first sensor type comprises a pressurized reference electrolyte.

13. The system according to claim 1, comprising a mechanism that is operable to bypass the second pH sensor to enable a cleaning in place (CIP) function to be provided.

14. A method for providing a mixed buffer liquid in a conduit, comprising:
supplying, by means of a supply arrangement, at least one of: a first buffer substance, a second buffer substance, or a salt substance to the conduit, thereby forming the mixed buffer liquid;
controlling a flow of the mixed buffer liquid to selectively bypass at least one of a first pH sensor and a second pH sensor of a control sensor arrangement, the first pH sensor being of a first sensor type and the second pH sensor being of a second sensor type;
receiving, from the control sensor arrangement, a signal indicating a pH level of the mixed buffer liquid downstream of the supply arrangement; and
controlling the operation of the supply arrangement based on the received signal.

15. The method according to claim 14, wherein controlling the operation of the supply arrangement comprises:
calculating the pH level of the mixed buffer liquid based on the received signal;
determining a difference between the calculated pH level and a predetermined pH level; and
providing relative mixing ratios of the first buffer substance and the second buffer substance based on the determined difference.

16. The method according to claim 14, comprising:
bypassing the first pH sensor in response to the mixed buffer liquid having a conductivity below 5 mS/cm, such as 2 mS/cm or less; and
bypassing the second pH sensor in response to the salt substance being supplied to the mixed buffer liquid.

17. The method according to claim 14, further comprising:
receiving, from a monitoring sensor arrangement, a monitoring signal indicating a pH level of the mixed buffer liquid;
determining that the pH level lies within a predetermined interval; and
releasing the mixed buffer liquid from the conduit.

18. The method according to claim 14, further comprising:
bypassing the second pH sensor; and
providing cleaning in place (CIP).

19. The method according to claim 18, wherein the CIP step is provided by supplying a CIP liquid comprising a sodium hydroxide solution.

20. The method according to claim 19, wherein the sodium hydroxide solution has about 0.5 M, about 1.0 M, or from about 0.5 M to about 1.0 M concentration.

21. The method according to claim 14, wherein the first buffer substance is an acid, the second buffer substance is a base, and the salt substance is NaCl.
